(19) United States
(12) Patent Application Publication
(10) Pub. No.: US 2010/0034466 A1
(43) Pub. Date: Feb. 11, 2010

(54) Object Identification in Images

(75) Inventors: Yushi Jing, Mountain View, CA (US); Michael Fink, Jerusalem (IL); Michele Covell, Palo Alto, CA (US); Shumeet Baluja, Leesburg, VA (US)

Correspondence Address: FISH & RICHARDSON P.C., PO BOX 1022, MINNEAPOLIS, MN, 55440-1022, US

(73) Assignee: GOOGLE INC., Mountain View, CA (US)

(21) Appl. No.: 12/538,283

(22) Filed: Aug. 10, 2009

Related U.S. Application Data
(60) Provisional application No. 61/188,748, filed on Aug. 11, 2008.

(51) Int. Cl. G06K 9/46

(52) U.S. Cl. 382/195

(57) ABSTRACT

A first indication of a portion of an image presented on a display device associated with a first user is received in response to a prompt to identify an object. A second indication of a portion of the image presented on a display device associated with a second user is received in response to a prompt to identify the object. A region-of-interest in the image is identified based on the first indication and the second indication. The region-of-interest is associated with an identifier of the object. A designator is associated with the region-of-interest in the image, the designator being configured to present information related to the object. Presentation of the designator associated with the region-of-interest in the image is enabled in subsequent presentations of the image.

### CROSS-REFERENCE TO RELATED APPLICATIONS

This application claims priority under 35 U.S.C. §119(e) to U.S. Provisional Application Ser. No. 61/188,748 titled “Object Identification In Images,” filed Aug. 11, 2008, the disclosure of which is incorporated herein by reference in its entirety.

### BACKGROUND

This disclosure relates to object identification. The Internet includes a large number of images, some of which are associated with displayable information. For example, a user might select an image of a dog and receive information about the dog, such as the breed, the name, etc.

### SUMMARY

A first indication of a portion of an image presented on a display device associated with a first user is received in response to a prompt to identify an object. A second indication of a portion of the image presented on a display device associated with a second user is received in response to a prompt to identify the object. A region-of-interest in the image is identified based on the first indication and the second indication. The region-of-interest is associated with an identifier of the object. A designator is associated with the region-of-interest in the image, the designator being configured to present information related to the object. Presentation of the designator associated with the region-of-interest in the image is enabled in subsequent presentations of the image.

The details of one or more implementations of the invention are set forth in the accompanying drawings and the description below. Other features, objects, and advantages of the invention will be apparent from the description and drawings, and from the claims.

### DESCRIPTION OF DRAWINGS

FIG. 1 is a block diagram of an example environment 100 in which regions-of-interests may be identified in images.

FIGS. 2-4 are illustrations of an example user interface for providing indications of portions of images.

FIG. 5 is an illustration of an example image including an identified region-of-interest.

FIG. 6 is an example user interface for displaying an image including a region-of-interest.

FIG. 7 is an example process flow for identifying a region-of-interest in an image.

FIG. 8 is an example process flow for identifying a region-of-interest in an image.

FIG. 9 is a block diagram of an example computer system that can be utilized to implement the systems and methods described herein.

Like reference numbers and designations in the various drawings indicate like elements.

### DETAILED DESCRIPTION

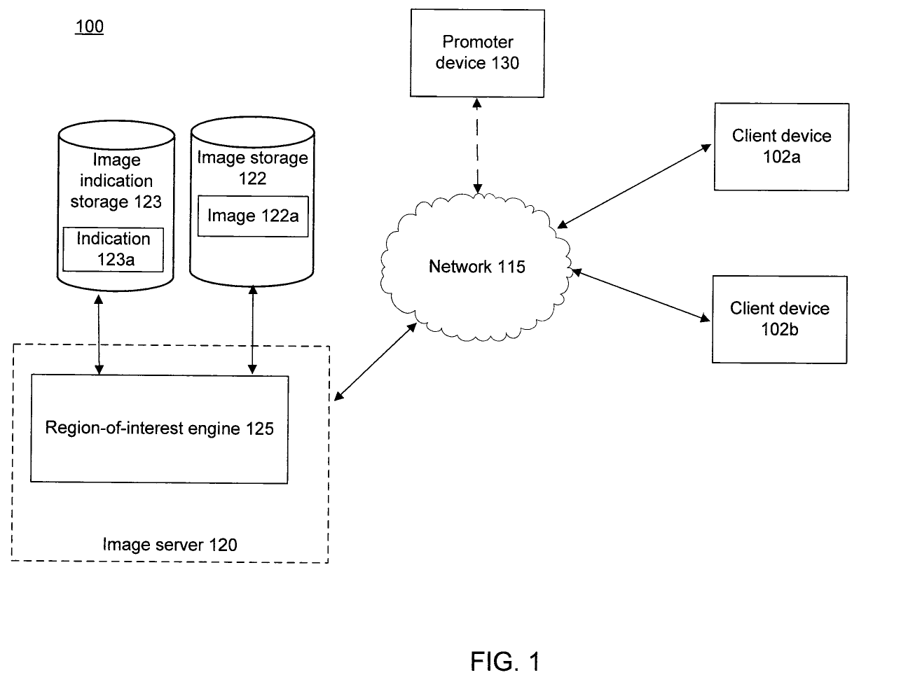

FIG. 1 depicts an example environment 100 in which regions-of-interests in images are identifiable by a user. In some implementations, in general, a user is able to identify where a particular type of object (such as a dog, a car, a building) appears in an image displayed on a display device accessible to the user. The type of object and the object's location within the image may be stored and enable retrieval later of the image based on the type of object.

In some implementations, to encourage a user to identify a type of object within an image, an “image treasure hunt” activity may be hosted such that users are encouraged to look through images to identify a particular object within a particular image. In one example, a particular image including a dog is selected as the target of the “image treasure hunt,” and users who are playing the game are told that the target is a dog. Users then proceed to search through images to find the particular image of the dog, which is the target of the “image treasure hunt.” Each time a user identifies an image with the dog, the user indicates the location of the dog in the image to see whether that dog in the image is the target of the “image treasure hunt.” As users identify dogs in various images, the locations of dogs in various images is stored to enable retrieval later of each image based on a dog being included in the image. As such, the “image treasure hunt” helps catalog the types of objects included in images.

More particularly, the environment 100 includes an image server 120 configured to provide images to client devices 102a and 102b through a network 115.

The image server 120 includes an image storage 122 storing images (such as image 122a). The image storage 122 and the image indication store 123 may be implemented using a variety of data storage techniques including, for example, a relational database or a distributed file system. In some implementations, the image storage 122 may be part of a map application with the images corresponding to addresses or locations on a map. Additionally or alternatively, the images or some of the images may be frames of a video content item, for example.

The image server 120 also includes an image indication storage 123 that stores indications (such as indication 123a) of an object within an image stored in image store 122. An image indication is associated with an image in the image storage 122. The image indications may be received from users viewing images at the client devices 102a and 102b, for example.

An image indication indicates a portion of an associated image. In some implementations, the portion may indicate or represent a pixel location, or a set of pixel locations in the associated image. Additionally or alternatively, the portion may include or represent boundary coordinates of the portion within or relative to the image, for example. Other techniques for denoting an area in an image may be used.

The image indications are associated with an identifier of an object from the associated image in the image storage 122. For example, the identifier of an object may identify the particular object in the image that the indicated portion purports to identify. In a more particular example, an identifier may indicate that the object in the image is a dog, a particular breed of dog, or a dog in a particular setting or forming a particular activity (such as a dog at a beach, a dog at a dog show, a German shepherd playing Frisbee). In some implementations, the granularity of what an identifier represents may be finer.

In some implementations, an identifier of an object may be provided by a user at the client device 102a or 102b. The indication of a portion of an image 121a may be further associated with a user identifier. The user identifier may identify the user that made the image selection that resulted in the particular indication of a portion of an image. The user identifiers may be anonymized such that the identifier cannot be used to identify the person associated with the user identifier, for example, but identifies the region of a country or world where the identification originated.

The image server 120 may further include a region-of-interest engine 125. The region-of-interest engine 125 may identify regions-of-interests in images stored in image storage 122 using the indications of portions of an image associated with the images having a common indication of an object. In some implementations, the region-of-interest engine 125 may identify a region-of-interest by combining the indicated portions of the image. For example, if a particular image has four associated indications of a portion of an image that have a common object identifier of “tree”, then the region-of-interest may be identified by combining, extrapolating or otherwise using the four indicated portion of an image to determine or approximate the image boundaries.

Additionally or alternatively, the region-of-interest engine 125 may identify a region-of-interest using the indicated portions of the image to generate an area or shape that encompasses or is otherwise associated with the indicated portions of the image. For example, where an image 122a has four associated indications of portions of the image, the region-of-interest engine 123 may identify the region-of-interest with a shape, such as circle, for example, that includes the four indicated portion of the image. The shape may be generated using a “best fit” or other shape generating algorithms, for example.

In some implementations, the region-of-interest engine 123 may identify and remove unreliable, inaccurate, mistaken or fraudulent (collectively, “unreliable”) indications before identifying the region-of-interests. In some implementations, the region-of-interest engine 123 may identify unreliable indications of a portion of an image using the associated user identifier. For example, the user identifier may have an associated user rating. The user rating may be based on a variety of factors including the number of indications of a portion of an image that are associated with the user identifier (e.g., a user identifier associated with a large number of associated indications may be more reliable than a user identifier with a small number of associated indications), and feedback from other users (e.g., other users may rate the quality of indications for accuracy). The region-of-interest engine 123 may consider indications based on reliability, such as only considering indications having an associated user identifier that identifies a user with a user score greater than a threshold score of reliability, for example.

In some implementations, the region-of-interest engine 123 may identify unreliable indications of a portion of an image by identifying indications that differ significantly from other indications having a common object identifier. Indications of a portion of an image with a common object identifier are likely to cluster together, or be located near one another in the same image. Thus, if a particular indication is located in a different region of the image than the other indications, the indication may be unreliable and may not be used by the region-of-interest engine 123 to identify the region-of-interest. For example, if a majority of indications of a portion of an image associated with a tree object in an image is generally located in a lower quadrant of an image, whereas an outlier indication is located in an upper quadrant, then the indication located in the upper quadrant may be considered to be unreliable. The region-of-interest engine 123 may then identify the region-of-interest without the unreliable indications, for example.

The image server 120 may provide incentives for users to provide indications of portions of images and associated object identifiers. An incentive may be provided in the form of a contest to find or identify a target or goal portion of the image. The contest may be associated with a prize, though a contest need not necessarily include a prize. In some implementations, a promoter server 130 may transmit designates of a region-of-interest in one or more images 122a as a goal or target region or object. For example, a sports car promoter may select an image 122a from the image storage 122 that includes the sports car. The promoter may identify a region-of-interest in the image corresponding to the sports car and designate the region-of-interest as the goal region. The promoter 130 may sponsor a contest, such as an “image treasure hunt,” where participants are asked to indicate portions of the images 122a in the image storage 122 that correspond to the sports car. If a participant provides an indication of a portion of an image that corresponds to the goal region in the image 122a, then the participant may be awarded a prize, for example. The indications of a portion in an image received from the participants in the contest can be used to identify regions-of-interest in the images of the image storage 122 and associate the regions-of-interest with an object identifier corresponding to the sport car. Through a contest, the promoter 130 may be able to incentivize users to provide indications of portion of images corresponding to the sports car in the image storage 122, for example.

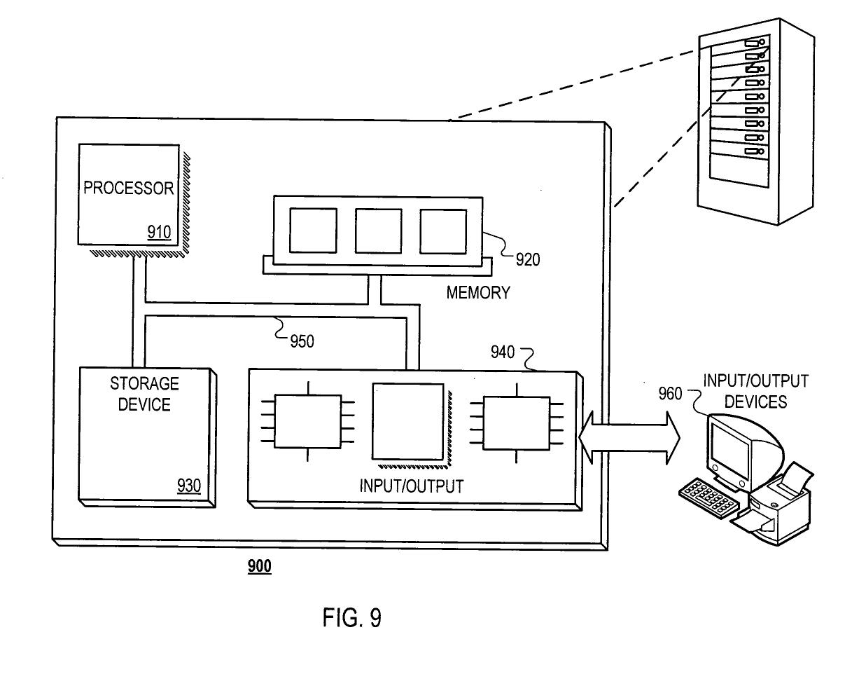

The image server 120 and the region-of-interest engine 123 may each be implemented on a single computer system, or as a distributed computer system including multiple computers (e.g., a server farm) and geographically distributed computers. An example computer system implementation is illustrated in FIG. 9, for example.

The client devices 102a and 102b may include a variety of network-capable devices, including desktop and laptop computers, personal digital assistants, cellular phones, smart phones, e-mail messaging portable devices, portable media players (such as a music player or a video player), videogame consoles, portable game devices and set-top boxes, or combinations thereof, for example.

The client devices 102a and 102b each are configured to receive and display an image from the image server 120. The client devices 102a and 102b also are configured to enable a user to identify an indication of an object in a displayed image.

For example, a user may click, or otherwise select, an object corresponding to a tree in an image displayed at the client device 102a or 102b. After selecting the object, the user may be prompted to provide an identifier of the object to which the selected portion of the image corresponds. Accordingly, the user may provide an identifier that the selection is a tree by typing “tree” or selecting a description from a displayed set of descriptions, for example.

In some implementations, the identifier of the object may have been determined prior to the user providing the indication. For example, a user of the client device 102a or 102b may be asked to identify car objects in a displayed image as part of a contest or promotion. Accordingly, any portions of the image that the user selects, or provides indications of, may be associated with a “car” object identifier, for example.

The client devices 102a and 102b each are configured to send the indication of the object in the displayed image to the image server 120. Other non client-server configurations are possible.

The indications may be sent from users viewing images on a display device, for example. An indication of a portion of an image may indicate or specify a region in a displayed image that a user feels corresponds to an object. The received indications associated with a particular image may be used to identify region-of-interests in the image corresponding to the objects in the image. The region-of-interests may then be associated with a user-selectable link that is configured to cause presentation of information related to the object when selected. When a later user requests the image, the user-selectable link associated with the region-of-interest is presented to the user along with the requested image. If the user then activates the user-selectable link, the information related to the object can be presented to the user.

For example, users may view an image including an object of a dog. The users may provide indications of the portion of the image that corresponds to the dog object. For example, the users may provide indications by clicking on the dog, or tracing an outline of the dog in the image. A region-of-interest corresponding to the dog in the image may be identified using the indications of portions of the image. For example, the received indications may be combined or aggregated to define the region-of-interest in the image. A hyper-link, or other user-selectable link, that is configured to cause information to be presented about the dog object may be associated with the region-of-interest. When a later user views the image and clicks, or otherwise selects, the region-of-interest in the image, the link can be activated and the information about the dog presented to the user. For example, a webpage about the dog may be retrieved and displayed to the user, or a pop-up window containing information about the dog may be displayed adjacent to the region-of-interest in the image.

In some implementations, the client devices 102a and 102b also may provide a user identifier along with the indication of the object in the image. The user identifier maybe stored in a cookie, or other file, at the client device 102a or 102b, for example. In other implementations, the user identifier may be provided by the user before the indication. For example, the user may login, or otherwise identify themselves, to the image server 120 before providing indications of a portion of an image. In addition, the user identifiers may be anonymized such that the identifier cannot be used to identify the person associated with the user identifier, for example.

The network 115 may include a variety of public and private networks such as a public-switched telephone network, a cellular telephone network, and/or the Internet, for example.

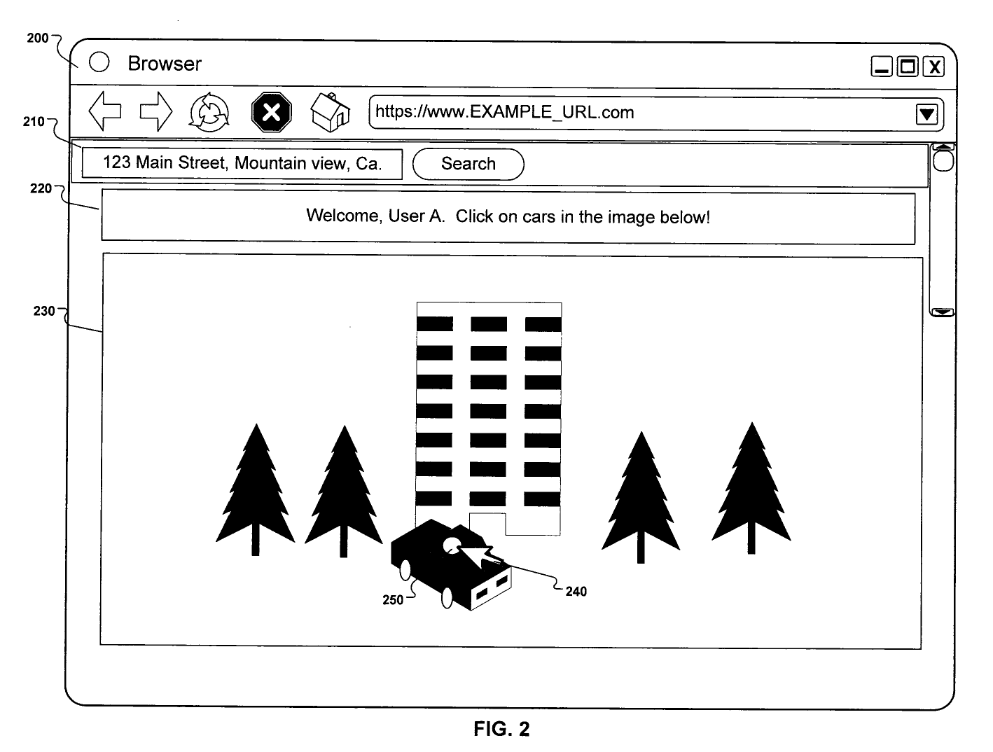

FIGS. 2-4 are illustrations of an example user interface 200 configured to enable a user to provide identifications of objects within an image. More particularly, the user interface 200 enables a user to provide indications of portions of images. The user interface 200 may be displayed on a client device (e.g., client devices 102a and 102b). In the examples shown in FIGS. 2-4, three users: user A; user B; and user C provide indications of portions of an image. In some implementations, the users may provide indications as part of a contest or a promotion, such as an “image treasure hunt.” A promoter (e.g., using promoter device 130) may define a region-of-interest in a particular image 122a in the image storage 122 as a goal region.

Participants in the contest attempt to find the goal region among the many images in the image storage 122 by clicking on, or otherwise selecting, objects in the images of the image storage 122. If a participant selects an object that is within the goal region, then the participant may be awarded a prize or some other consideration.

In the examples shown in FIGS. 2-4, the image storage 122 is a database of images corresponding to street addresses. The image storage 122 may be part of a map application, for example. As part of the contest, the promoter 130 may select as the goal region a region in the image of a particular car in one or more of the images 122a corresponding to a particular street address as the goal region. The users A, B, and C attempt to locate the goal region using the user interface 200, for example.

The user interface 200 includes a goal display 220. The goal display 220 identifies the user and provides a message describing the goal of the contest in which the user is participating. For example, in FIG. 2, the goal display 220 dispays “Welcome User A. Click on cars in the image below” indicating the identity of the user as user A and instructing the user to locate cars in the image displayed in window 230. In some implementations, the user may provide credentials, through a login, cookie, or other identifier, allowing the user to be identified for the contest and in the goal display 220, for example.

The user interface 200 includes an address selection field 210. The address selection field 210 is configured to receive an address entered by a user. As illustrated in FIGS. 2-4, the users each have entered the address “123 Main street, Mountain view, Calif.” After submitting the entered address using the “Search” button, for example, the address is sent to the image server 120, and, in response, the image server 120 sends an image 122a corresponding to the submitted address to be received and displayed at the client device 102a, for example. As illustrated in FIGS. 2-4, the corresponding image 122a is displayed in a display window 230, for example.

The display window 230 displays the image 122a associated with the address submitted in the address selection field 210. In addition, the client device 102a is configured to receive from the users an indication or indications of portions of the image shown display window 230. As illustrated in FIGS. 2-4, the users may provide indications of portions of the image using the cursor 240. The portions of the image indicated by the user A, B, and C are illustrated by portions 250, 350, and 450 in FIGS. 2-4, respectively.

In the example illustrated in FIGS. 2-4, the three users are participating in the contest to locate the goal region. As indicated in the goal displays 220 in FIGS. 2-4, the users attempt to locate a goal region that corresponds to a particular car. Accordingly, each of the users have selected the car object in the image shown in the display window 230.

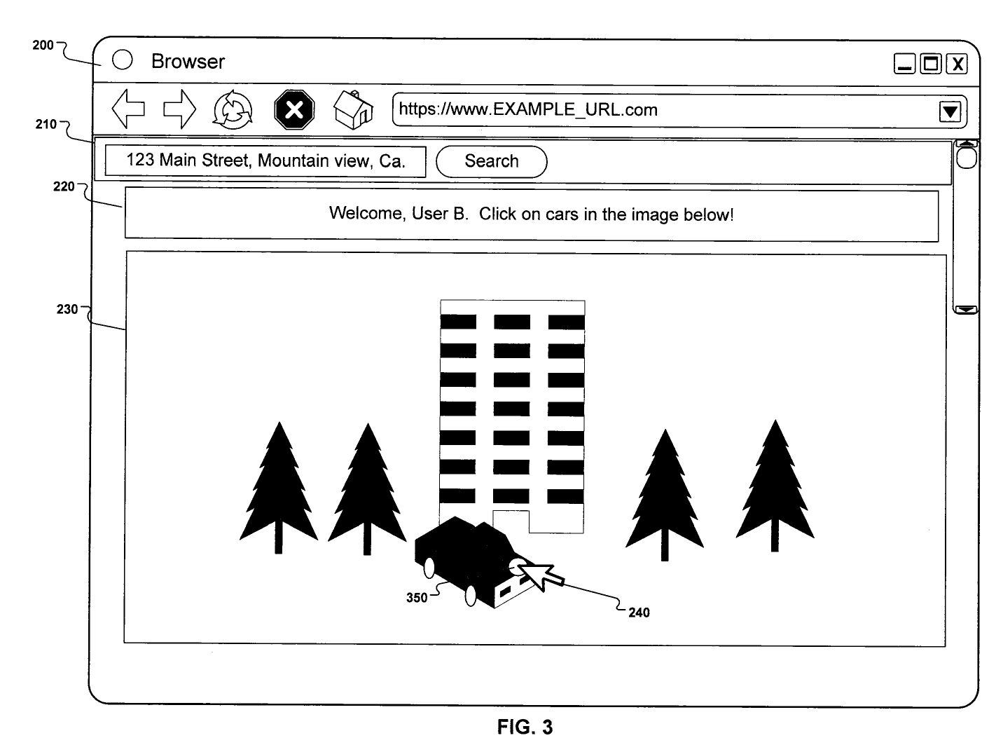

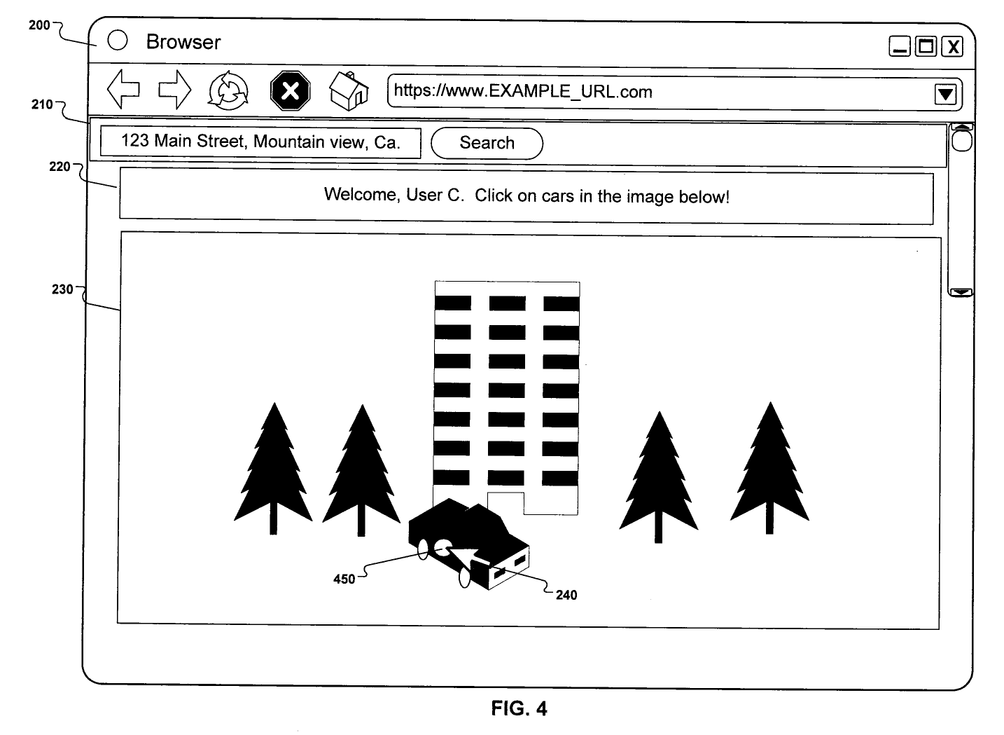

Each selection made by a user may result in an indication of a portion of the image. For example, as shown in FIG. 2, user A selected near the top of the car object as illustrated by the portion of the image 250. As shown in FIG. 3, user B selected near the trunk of the car object as illustrated by the portion of the image 350. As shown in FIG. 4, user C selected near the side of the car object as illustrated by the portion of the image 450. The indications 250, 350 and 450 of a portion of the image are sent to the image server 120, where the portions are associated with the image and stored in the image indication storage 121, for example.

In addition, the indications 250, 350 and 450 may be further associated with an object identifier and/or a user identifier. Because the users are participating in a content to locate a goal region corresponding to a car, the indications received from the users may be associated with a “car” object identifier. Each indication may be further associated with a user identifier identifying the user that provided the indication (e.g., user A, B, or C).

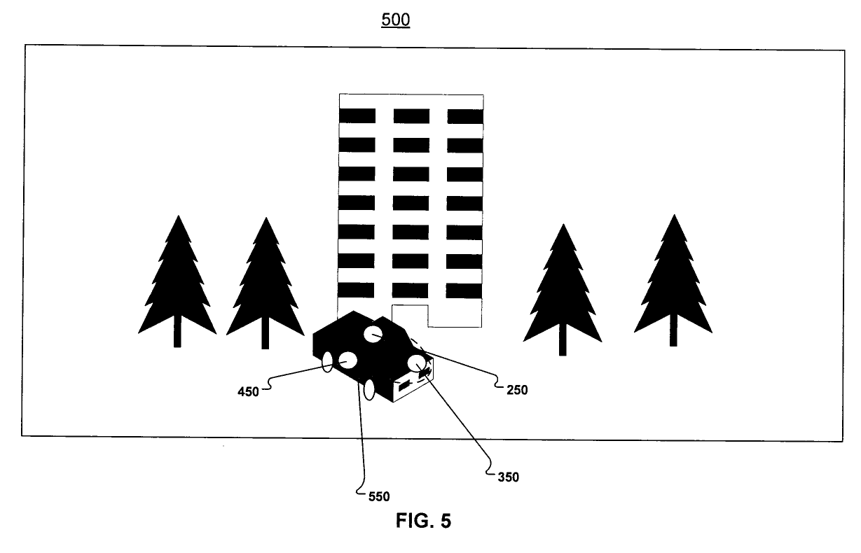

FIG. 5 is an illustration of an example image 500 including an identified region-of-interest. Continuing the example described above with respect to FIGS. 2-4, users A, B, and C have made selections to the car object shown in the image 500 resulting in the indications of portions of an image 250, 350, and 450 being sent to the image server 120.

The received indications of portions of an image 250, 350, and 450 may be used to identify a region-of-interest 550 in the image 500. The region-of-interest may be identified by the region-of-interest engine 123, for example. In some implementations, the region-of-interest may be identified by combining pixels from the portions of the image corresponding to the received indication(s) for that image having the same identifier of an object. For example, the region-of-interest 550 may be identified by combining the pixels indicated by the received portions of the image associated with the object car (i.e., portions of the image 250, 350, 450). In some implementations, the region-of-interest 550 may be identified by generating a shape or area encompassing the portions of the image associated with the same object.

As illustrated, the region-of-interest 550 is an area that is identified to include the portions of the image 250, 350, and 450 having the common object identifier of car. The boundaries of the region-of-interest 500 include the boundaries of the portions of an image 250, 350, and 450, and also include portions of the image that were not identified. Because objects in images are continuous, the areas between indicated portions of an image may likely also be associated with the object in the image.

The identified region-of-interest 550 may be associated with an indication of an object. Continuing the example described above, the identified region-of-interest 550 may be associated with an indication of the car object, for example. Further, the identified region-of-interest 550 may be associated with a user-selectable link. The user-selectable link can be configured to present information related to the object associated with the region-of-interest 550. For example, the user-selectable link may be configured to present information related to the car object when selected.

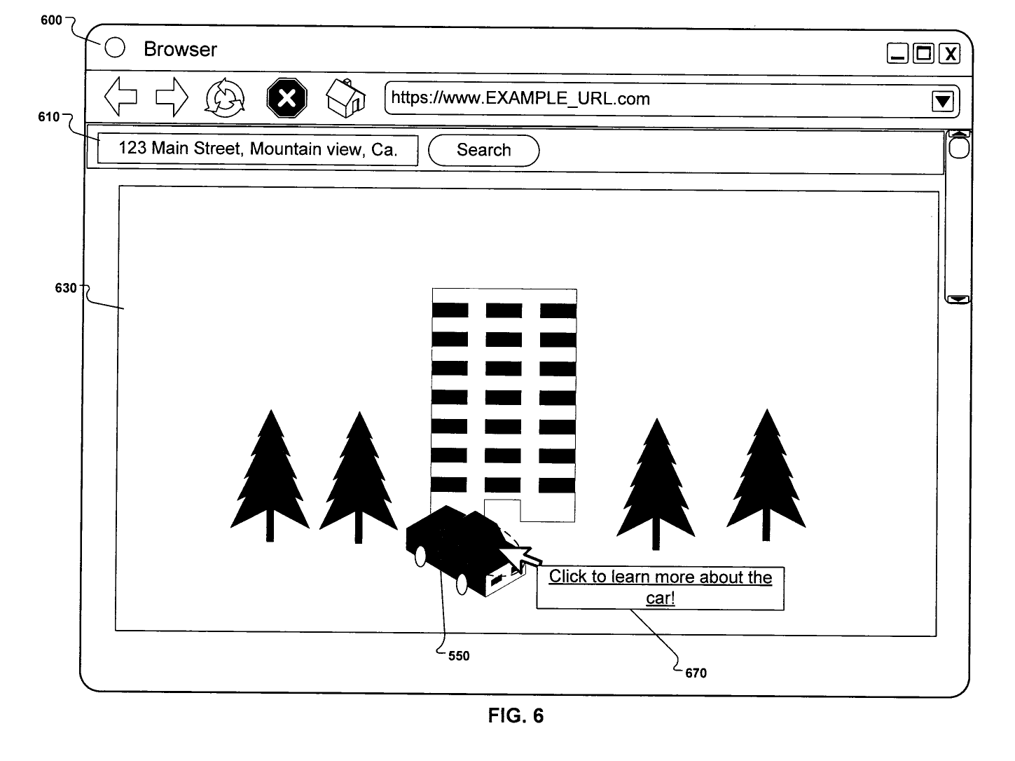

FIG. 6 is an example user interface 600 for displaying an image including a region-of-interest. The user interface 600 may include an address selection field 610 for specifying an address of which to view an associated image, and a display window 630 for displaying the image associated with the entered address.

Continuing the example described with respect to FIGS. 2-5, a user requested to view an image corresponding to the address entered into the address selection field 610. The image corresponding to the entered address “123 Main street, Mountain view, Calif.” is displayed in the display window 630.

As described in FIGS. 2-5, the image corresponding to the address has an associated region-of-interest 550 with an associated user-selectable link. The region-of-interest is identified using indications of portions of an image received during a contest to locate a goal image, and is associated with the image and a user-selectable link. When a user requests the image through the user interface 600, the image is retrieved from the image server 120 along with the associated user-selectable link. The image is displayed by the client device 120a in the display window 630 along with the associated region-of-interest 550 the associated user selectable link.

As shown, a user clicked, or otherwise selected, the region-of-interest 550 in the image. Accordingly, the use selectable link associated with the region-of-interest 550 is activated resulting in the display of the text box 670. In the example shown, the text box 670 includes a hyper-link to a webpage to display additional information about the car to the user.

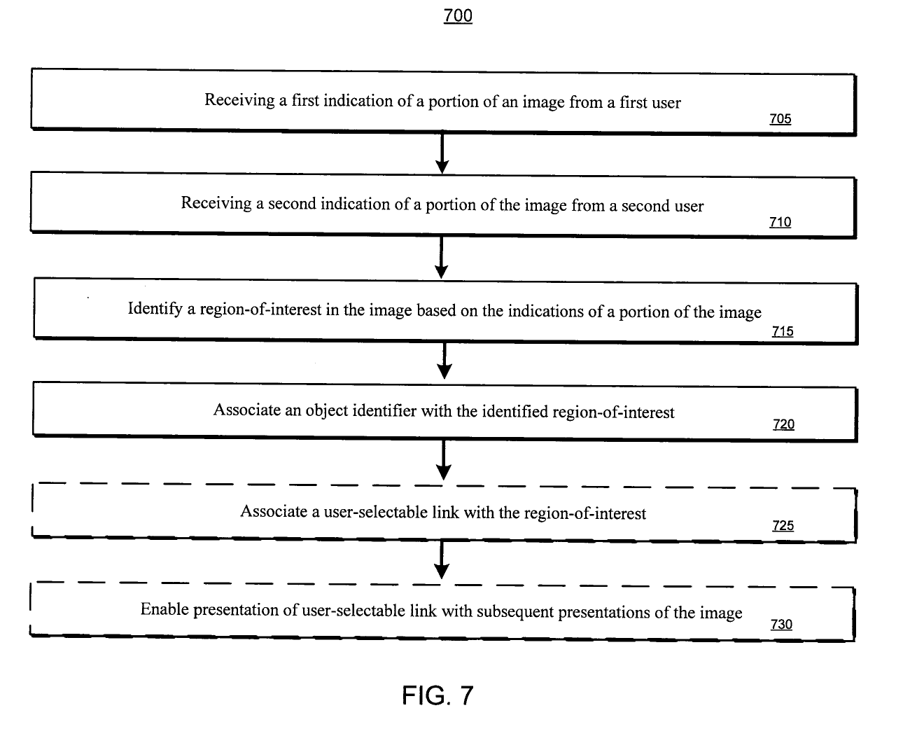

FIG. 7 is an example process flow 700 for identifying a region-of-interest in an image. The process flow may be implemented by the image server 120, for example.

A first indication of a portion of an image presented on a display device associated with a first user is received (705). The first indication of a portion of an image may be received by the image server 120 from a client device 102a when a user indicates a portion of the image, for example. In some implementation the indication may indicate a pixel or pixel location in the image presented on the display device of the client device.

In some implementations, the indication is received in response to a prompt to identify an object. For example, the user may be prompted to locate an object such as a car in an image presented on the display device. Accordingly, the user may click on, or otherwise select, a portion of the image on the display device that the user purports to be a car. An indication of the selected portion is then sent by the client device 102a and received by the image server 120, for example.

A second indication of a portion of the image presented on a display device associated with a second user is received (710). The second indication of a portion of an image may be received by the image server 120 from a client device 102b when a second user indicates a portion of the image, for example.

A region-of-interest in the image is determined based on the first indication and the second indication (715). The region-of-interest in the image may be identified by the region-of-interest engine 123 of the image server 120, for example. In some implementations, the region-of-interest may be identified by combining the indicated portions of the image. Additionally or alternatively, the region-of-interest may be identified by generating a shape or area that encompasses the first and second indicated portions, for example.

The region-of-interest is associated with an indication of the object (715). The region-of-interest may be associated with the indication of the object by the region-of-interest engine 123 of the image server 120, for example.

Optionally a user-selectable link or other designator may be associated with the region-of-interest in the image (720). The user-selectable link may be associated with the region-of-interest of the image by the region-of-interest engine 123 of the image server 120, for example. In some implementations, the user-selectable link is configured to present information related to the object when selected by a user. For example, where the object is a car, the user-selectable link may cause a window to display information about the car when a user selects the region-of-interest in the image. Similarly, the user-selectable link may cause an Internet browser to open to a webpage associated with the car when a user selects the region-of-interest.

The user-selectable link or other designator associated with the region-of-interest in the image is displayed in subsequent presentations of the image (725). The user-selectable link may be presented with by the image server 120, for example. A user at a client device 102a may request the image from the image server 120. When the image server 120 presents the requested image to the client device 102a, the image server 120 also presents the associated user-selectable link to the user device 102a. The client device 102a may then present the image and associated link to the user on a display device associated with the client device 102a, for example. Additionally or alternatively, the image server may send the user-selectable link and image (or indications thereof) to another server for subsequent presentation.

In some implementations, an image server may determine and disregard outlier indications that are substantially different from other indications of an object in an image when identifying the object in the image.

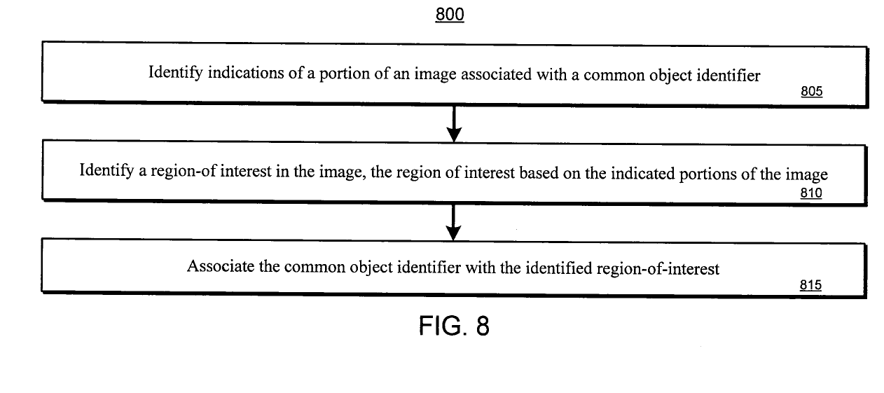

FIG. 8 is another example process flow 800 for identifying a region-of-interest in an image. The process flow may be implemented by the image server 120, for example.

Indications of a portion of an image are received from different users (805). The indications of a portion of an image may be received by an image server 120 from client devices (e.g., client devices 102a and 102b). In some implementations, the image may be part of an image collection stored at the image storage 122 of the image server 120. The image collection may be part of a map application or may be a video content item, for example.

The received indications also may include or be associated with object identifiers that identify an object in the associated image that the indication purports to identify. In some implementations, the associated object identifiers may be provided by users associated with the client devices that provided the particular indications. In other implementations, the object identifiers may be provided by the image server 120. For example, where indications of a portion of an image are received from users participating in a contest or promotion to locate a goal region depicting a particular type of object, the associated object identifier may correspond to the object specified by the promotion.

A region-of-interest in the image is determined based on the indications of a portion of the image having a common associated object identifier (810). The region-of-interest may be identified by the region-of-interest engine 123 of the image server 120, for example. In some implementations, the region-of-interest may be identified by combining the portions of images having a common associated object identifier. For example, where the portions of images identify pixel regions in the image, the identified region-of-interest may include the identified pixel regions. Additionally or alternatively, the identified region-of-interest may be identified by generating a shape or area that encompasses the indications.

The common associated object identifier is associated with the identified region-of-interest (815). The object identifier may be associated with the identified region-of-interest by the region-of-interest engine 123 of the image server 120, for example.

In one example of an implementation of the process 800, various users may be registered or otherwise identified as participating in an “image treasure hunt” to identify a particular cat shown in a particular image. As each of the users browses and displays images in the image store, the users identify every depiction of a cat shown in an image a user has browsed and displayed. When a user identifies a depiction of a cat, the user's client device sends to the image server an indication of the portion of the image that the user identified as depicting a cat, an indication identifying the image in which the cat depiction occurs, and an object identifier to identify the identified portion of the image as depicting a cat. The image server groups information for a particular image submitted by different users and processes the information about the image to identify a region of interest (here, the depiction of the cat) based on the portions of the images submitted for the common object identifier “cat.” In that way, the image server is able to store an indication that the image includes a depiction of a cat and the location of the cat depiction in the image.

FIG. 9 is a block diagram of an example computer system 900 that can be utilized to implement the systems and methods described herein. For example, the image server 120 may be implemented using the system 900.

The system 900 includes a processor 910, a memory 920, a storage device 930, and an input/output device 940. Each of the components 910, 920, 930, and 940 can, for example, be interconnected using a system bus 950. The processor 910 is capable of processing instructions for execution within the system 900. In one implementation, the processor 910 is a single-threaded processor. In another implementation, the processor 910 is a multi-threaded processor. The processor 910 is capable of processing instructions stored in the memory 920 or on the storage device 930.

The memory 920 stores information within the system 900. In one implementation, the memory 920 is a computer-readable medium. In one implementation, the memory 920 is a volatile memory unit. In another implementation, the memory 920 is a non-volatile memory unit.

The storage device 930 is capable of providing mass storage for the system 900. In one implementation, the storage device 930 is a computer-readable medium. In various different implementations, the storage device 930 can, for example, include a hard disk device, an optical disk device, or some other large capacity storage device.

The input/output device 940 provides input/output operations for the system 900. In one implementation, the input/output device 940 can include one or more of a network interface devices, e.g., an Ethernet card, a serial communication device, e.g., and RS-232 port, and/or a wireless interface device, e.g., and 802.11 card. In another implementation, the input/output device can include driver devices configured to receive input data and send output data to other input/output devices, e.g., keyboard, printer and display devices 960.

The apparatus, methods, flow diagrams, and structure block diagrams described in this patent document may be implemented in computer processing systems including program code comprising program instructions that are executable by the computer processing system. Other implementations may also be used. Additionally, the flow diagrams and structure block diagrams described in this patent document, which describe particular methods and/or corresponding acts in support of steps and corresponding functions in support of disclosed structural means, may also be utilized to implement corresponding software structures and algorithms, and equivalents thereof.

This written description sets forth the best mode of the invention and provides examples to describe the invention and to enable a person of ordinary skill in the art to make and use the invention. This written description does not limit the invention to the precise terms set forth. Thus, while the invention has been described in detail with reference to the examples set forth above, those of ordinary skill in the art may effect alterations, modifications and variations to the examples without departing from the scope of the invention.

What is claimed is:

1. A computer-implemented method comprising:
receiving, by at least one processor, a first indication of a portion of an image presented on a display device associated with a first user, the first indication being received in response to a prompt to identify an object;
receiving, by at least one processor, a second indication of a portion of the image presented on a display device associated with a second user, the second indication being received in response to a prompt to identify the object;
identifying, by at least one processor, a region-of-interest in the image based on the first indication and the second indication;
associating, by at least one processor, the region-of-interest with an identifier of the object;
associating, by at least one processor, a designator with the region-of-interest in the image, the designator being configured to present information related to the object; and
enabling, by at least one processor, presentation of the designator associated with the region-of-interest in the image in subsequent presentations of the image.

2. A computer-implemented method comprising:
receiving, by at least one processor, a plurality of indications of a portion of an image, wherein the image is part of an image collection and the indications having an associated object identifier;
identifying, by at least one processor, a region-of-interest in the image based on the indications of a portion of the image having a common associated object identifier; and
associating, by at least one processor, the common associated object identifier with the identified region-of-interest.

3. The method of claim 2, wherein the indications are further associated with a user, and each user is associated with a user score, and further wherein identifying a region-of-interest in the image based on the indications of a portion of the image having a common associated object identifier comprises identifying a region-of-interest in the image based on the indications of a portion of the image having a common associated object identifier and having an associated user with an associated user score greater than a threshold user score.

4. The method of claim 2, further comprising:
defining a goal region in one or more of the images in the image collections; and
determining if a received indication of a portion of an image indicates a portion of a goal region.

5. The method of claim 4, wherein the indications are further associated with a user, and further comprising if it is determined that a received indication of a portion of an image indicates a portion of a goal region, awarding a prize to the user associated with the received indication.

6. The method of claim 2, further comprising identifying fraudulent indications, and further wherein identifying a region-of-interest in the image based on the indications of a portion of the image having a common associated object identifier comprises identifying a region-of-interest in the image based on non-fraudulent indications of a portion of the image having a common associated object identifier.

7. The method of claim 2, further comprising associating a user-selectable link with the identified region-of-interest.

8. The method of claim 2, wherein the image collection is a video content item.

9. The method of claim 2, wherein the image collection is part of a map application.

10. A system comprising:
a data store adapted to store a plurality of images and associated indications of a portion of the images, wherein indications have an associated object identifier and an associated user; and
a processor adapted to:
identify indications of a portion of an image associated with a common object identifier;
identify a region-of interest in the image, the region-of-interest based on the indicated portions of the image; and
associate the common object identifier with the identified region-of-interest.

11. The system of claim 10, wherein the processor is further adapted to:
identify fraudulent indications stored in the data store; and
remove the fraudulent indications from the data store.

12. The system of claim 10, wherein the processor is further adapted to:
determine a score for each user associated with an indication; and
remove indications from the data store that have an associated user with a determined score less than a threshold score.

13. Instructions encoded on computer readable media that when executed cause a computer to perform operations comprising:
receiving a first indication of a portion of an image presented on a display device associated with a first user, the first indication being received in response to a prompt to identify an object;
receiving a second indication of a portion of the image presented on a display device associated with a second user, the second indication being received in response to a prompt to identify the object;
identifying a region-of-interest in the image based on the first indication and the second indication;
associating the region-of-interest with an identifier of the object;
associating a designator with the region-of-interest in the image, the designator being configured to present information related to the object; and
enabling presentation of the designator associated with the region-of-interest in the image in subsequent presentations of the image.

14. Instructions encoded on computer readable media that when executed cause a computer to perform operations comprising:
receiving a plurality of indications of a portion of an image, wherein the image is part of an image collection and the indications having an associated object identifier;
identifying a region-of-interest in the image based on the indications of a portion of the image having a common associated object identifier; and
associating the common associated object identifier with the identified region-of-interest.

15. The method of claim 14, wherein the indications are further associated with a user, and each user is associated with a user score, and further wherein identifying a region-of-interest in the image based on the indications of a portion of the image having a common associated object identifier comprises identifying a region-of-interest in the image based on the indications of a portion of the image having a common associated object identifier and having an associated user with an associated user score greater than a threshold user score.

16. The method of claim 14, further comprising:
defining a goal region in one or more of the images in the image collections; and
determining if a received indication of a portion of an image indicates a portion of a goal region.

17. The method of claim 16, wherein the indications are further associated with a user, and further comprising if it is determined that a received indication of a portion of an image indicates a portion of a goal region, awarding a prize to the user associated with the received indication.

18. The method of claim 14, further comprising identifying fraudulent indications, and further wherein identifying a region-of-interest in the image based on the indications of a portion of the image having a common associated object identifier comprises identifying a region-of-interest in the image based on non-fraudulent indications of a portion of the image having a common associated object identifier.

19. The method of claim 14, further comprising associating a user-selectable link with the identified region-of-interest.

20. The method of claim 14, wherein the image collection is a video content item.
